(19) United States
(12) Patent Application Publication
(10) Pub. No.: US 2019/0279163 A1
(43) Pub. Date: Sep. 12, 2019

(54) Good News Planner

(71) Applicant: Allen Sanders, Lakewood, WA (US)

(72) Inventor: Allen Sanders, Lakewood, WA (US)

(21) Appl. No.: 15/917,584

(22) Filed: Mar. 10, 2018

(51) Int. Cl. G06Q 10/10

(52) U.S. Cl. CPC G06Q 10/1093

(57) ABSTRACT

A novel form of Daily Planner/Weekly Planner/Monthly Planner/Yearly Agenda that helps increase productivity. The hardcover organizer is durable to endure it withstands perpetual use through the year. Good News Planner features full monthly view pages that have a prayer and bible verses for the month, with bible verses on each calendar date. Separate pages with a full weekly view for more detailed planning, with the complete bible scripture for each day and weekly prayer. All days have equal space, including Saturday & Sunday whereas printed with high-quality premium paper to reduce ink bleeding.

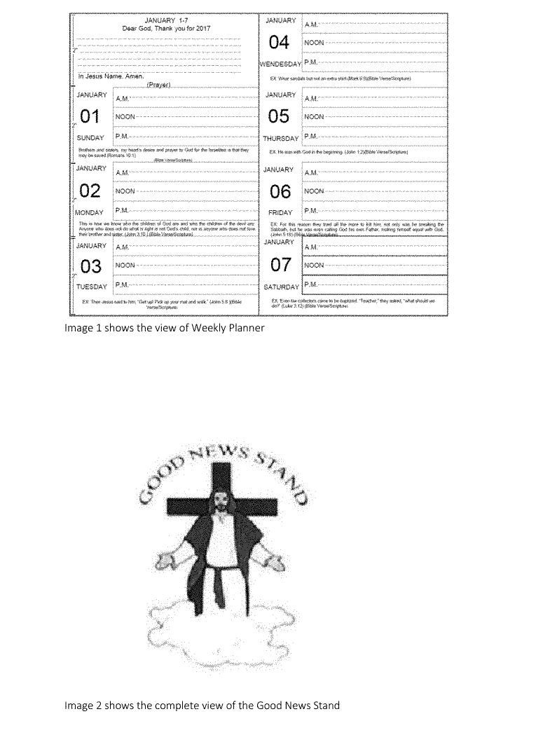

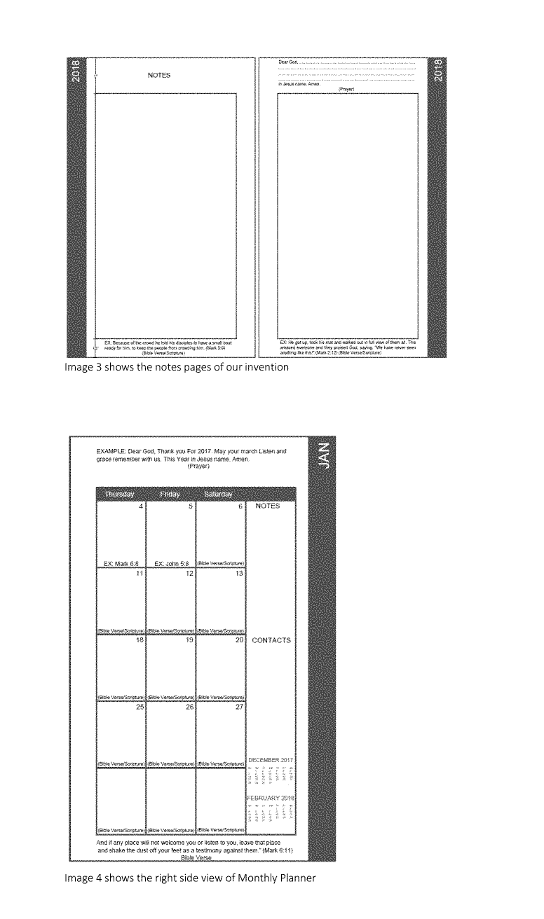

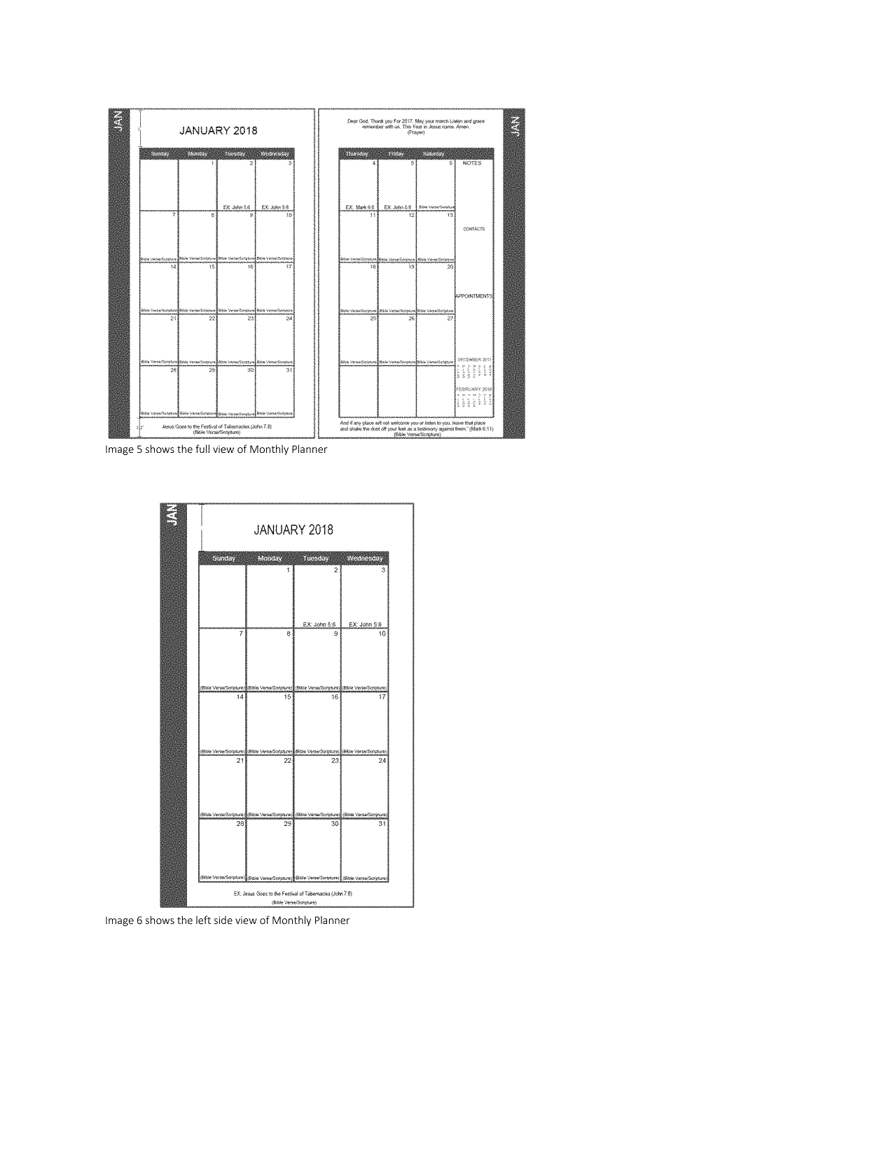

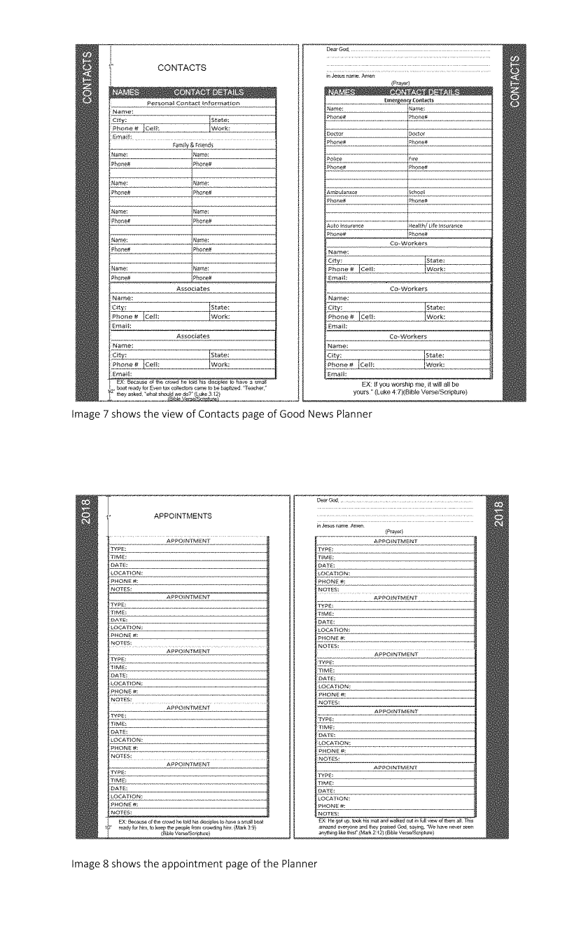

### BACKGROUND

### Field of the Invention

This invention relates generally to yearly planning and more specifically to a modular planner which allows an individual to plan their time on monthly and weekly activities with the bible verses or prayer on each calendar date. The invention, substitutable for conventional planners, which will provide further convenience, cost beneficial, easy maintenance, and satisfaction for the user without compromising the original functionality required.

### Description of the Related Art

Planning is an integral part of any individual daily activity. People plan and they love to plan their activities, which can be in their mind or on a piece of paper. Human mind is naturally made on the format of planning. Planning is a fundamental cognitive skill that forms part of human executive functions. Planning can be defined as ability to “think about the future” or mentally anticipate the right way to carry out a task or reach a specific goal.

Planning is the mental process that allows the individual to choose the necessary actions to reach a goal, decide the right order, assign each task to the proper cognitive resources, and establish a plan of action.

Even though everyone has the ability to plan, some people do it in a different way. This executive function depends on elements like brain plasticity or neuroplasticity, myelinization, establishing new paths or synaptic connections, etc. In order to plan efficiently, one needs the necessary information, but also need to be able to mentally establish an adequate synthesis of all the data.

Deterioration or an alteration in the planning ability makes some things more difficult, like, for example, organizing an event or activity, shopping, following instructions, completing a task, packing a backpack for school, etc.

The good news is that the mental processes used in planning (creating goals, making plans, etc.) can be further aided with the use of multiple techniques. For instance, Planners are one of the most widely used item for planning. People like to keep diaries, pocket diaries, calendars and planners to mark their activities, upcoming events and important notes. Planners are the advanced version of diaries, pocket diaries and other writing aids, which has a separate page for each day. This allows the individual to maintain the track of their activities and plan their future activities on a piece of paper, which is always accessible to them.

Multiple types of planners are available in the market. For instance a Calendar and appointment journal having US Patent 6,089,607 issued to Alliance Marketing Concepts LC is a calendaring and journal device is disclosed which is configured to enable the organized and compartmentalized recordation and annotation of appointments and notes within a structure which is designed to save paper while still giving an expanded capability for note-taking. The calendaring and journal device of the present invention is also structured to provide quick and easy access to the information annotated in any week and to enable the selective movement of information from one section to another without having to re-enter notes or information.

A U.S. Pat. No. 5,433,546 issued to Kershaw; Samuel H. is a planning and journal apparatus and method wherein a loose-leaf binder has mounted therein a plurality of indices, each index addressing a particular topic, one topic being a journal designed for regular journal entries. A week manager sheet is readily insert able between the pages of the journal without the necessity of opening and closing the rings of the loose-leaf binder. The week manager sheet selectively includes a subtask column to enable the user to readily identify various subtasks on a weekly basis. The week manager sheet is configured as a two-sided sheet and having ring-receiving holes along opposing margins. The holes are slit to the edge of the week manager sheet to allow each hole to be slipped over and removed from the respective ring without opening the rings.

The Good News Planner is a hardcover organizer which is durable to endure it withstands ongoing use through the year. Good News Planner features full monthly view pages that have a prayer and bible verses for the month, with bible verses on each calendar date. Separate pages with a full weekly view for more detailed planning, with the complete bible scripture for each day and weekly prayer.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary objective of this invention is to provide improvements in the method of planning activities, scheduling appointments, setting goals, and the like.

Another objective of the invention is to provide a planner which has Bible Verses written with each page number.

Another objective of the invention is to provide a durable hardcover which protects the inner pages from damage and sustains heavy use and last for years.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

Image 1 shows the view of Weekly Planner;

Image 2 shows the complete view of the Good News Stand;

Image 3 shows the notes pages of our invention;

Image 4 shows the right side view of Monthly Planner;

Image 5 shows the full view of Monthly Planner;

Image 6 shows the left side view of Monthly Planner;

Image 7 shows the view of Contacts page of Good News Planner;

Image 8 shows the appointment page of the Planner.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The present invention relates to a method to conveniently allow the user to keep track of their activities in a convenient and effective manner.

The invention in its preferred embodiment allows its users to stay focused on God throughout the day. Good News Planner provides Monthly and Weekly Prayers, with daily Bible Scriptures while accommodating the scheduling needs.

The invention in its current embodiment discloses a planner with durable hardcover that protects the inner pages from damage and sustains heavy use and last for years. It will keep an individual organized everywhere he/she go, while allowing fast and easy access to any month throughout the year with its premium monthly tabs.

The planner in its prefeed embodiment states provides a setup where each month is separated with durable, coated tabs that withstand constant use throughout the year. The planner features full monthly view pages, with prayers and bible verses. Moreover, separate pages with a full weekly view for more detailed planning with complete written bible scriptures and prayers is presented. The planner exhibits a contact and notes pages to accommodate the individual's scheduling needs

In its additional embodiment a previous and next month reference calendar on monthly view pages for long term planning is also printed. Moreover, major holidays are listed, elapsed and remaining days are also mentioned.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. The present invention is a Good News Planner where:
a good news planner according to claim 1, where the planner can be in any size according to claim 1, where the planner provides Monthly and Weekly Prayers, with daily Bible Scriptures while accommodating the scheduling needs a good news planner according to claim 1, where the planner month is separated with durable, coated tabs that withstand constant use throughout the year.
a good news planner according to claim 1, where major holidays, elapsed and remaining days are noted.

2. A Good News planner which has been developed with the use of premium paper ensuring reduction in ink bleeding, printed with high quality soy based ink is acid free and is made of recyclable material packed in a religious style cover.
